(19) United States
(12) Patent Application Publication
(10) Pub. No.: US 2015/0251696 A1
(43) Pub. Date: Sep. 10, 2015

(54) BRACKET TO INSTRUMENT PANEL INTERFACE

(71) Applicant: Steering Solutions IP Holding Corporation, Saginaw, MI (US)

(72) Inventors: Nicholas M. Messing, Freeland, MI (US); Robert W. Dubay, Saginaw, MI (US); David W. Koehler, Linden, MI (US)

(21) Appl. No.: 14/642,166

(22) Filed: Mar. 9, 2015

Related U.S. Application Data
(60) Provisional application No. 61/949,719, filed on Mar. 7, 2014.

(51) Int. Cl. B62D 7/22; B62D 1/19

(52) U.S. Cl. CPC B62D 7/224; B62D 1/19

(57) ABSTRACT

A column assembly for a steering column is provided. The column assembly includes a bracket configured to support a steering column assembly. The bracket has a first portion for receiving the column assembly and a second portion including a flange portion extending from said first portion. The flange portion includes apertures therethrough, and the flange further includes a flange surface configured for attachment. At least one stability pad is attached to the surface.

### CROSS-REFERENCE TO RELATED APPLICTION

This application is based upon and claims benefit of the filing date of U.S. Provisional Patent Application 61/949,719 filed on Mar. 7, 2014 and entitled “Bracket to Instrument Panel Interface,” which is incorporated herein by reference in its entirety.

### BACKGROUND OF THE INVENTION

The invention relates to interface contact between the instrument panel (IP) and a steering column

Current column designs achieve 46 Hz of natural frequency on a rigid fixture. Currently manufacturers are requiring of next generation column design to achieve 48 Hz of natural frequency on a rigid fixture.

### SUMMARY OF THE INVENTION

In an exemplary embodiment of the invention, a column assembly for a steering column is provided. The column assembly includes a bracket configured to support a steering column assembly. The bracket has a first portion for receiving the column assembly and a second portion including a flange portion extending from said first portion. The flange portion includes apertures therethrough, and the flange further includes a flange surface configured for attachment. At least one stability pad is attached to the surface.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view, shown partially in phantom, of an exemplary embodiment of the invention.

FIG. 2 is another perspective view, shown partially in phantom of an exemplary embodiment of the invention.

FIG. 3A is a schematic cross sectional view of an exemplary embodiment of the invention.

FIG. 3B is a schematic cross sectional view of an alternative embodiment of the invention.

### DETAILED DESCRIPTION

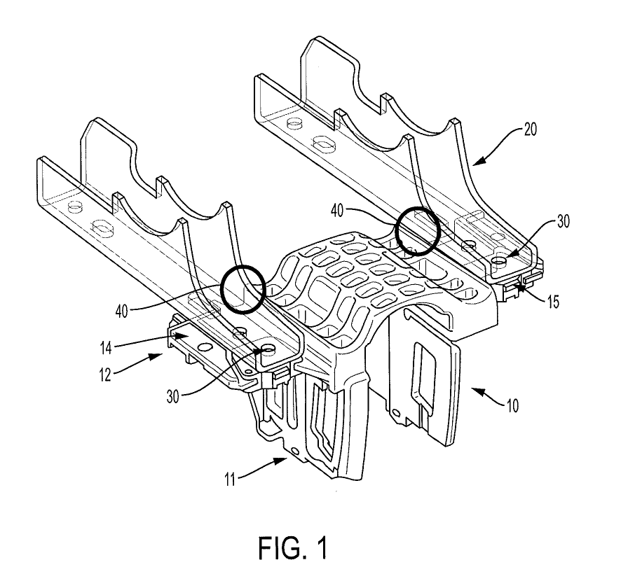

Referring now to the Figures, where the invention will be described with reference to specific embodiments, without limiting same, FIG. 1 illustrates a column bracket 10 attached to an instrument panel structure (IP) 20 of a vehicle.

In an exemplary embodiment, the column bracket 10 is a casting and is adapted to support a column (not shown). The bracket includes a first portion 11 through which the column is supported and a second portion 12 extending therefrom having complementary flanges 14 and 15. Bracket 10 is attached to the vehicle IP structure 20 through capsules 30 plastic injected into each of flanges 14 and 15.

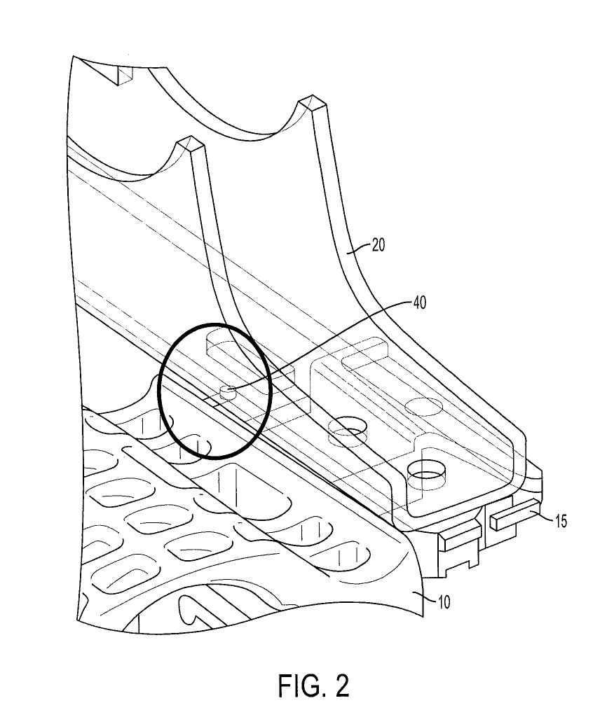

Referring to FIGS. 1, 2, and 3A, in the exemplary embodiment shown, and to gain another point of contact, small stability pads 40 are implemented on the bracket 10. Small stability pads 40 are configured to be interposed between bracket 10 and vehicle IP structure 20. Small stability pads 40 co-act with vehicle IP structure 20 by providing an abutting or a face-to-face interaction point at each of stability pads 40 between bracket 10 and vehicle IP structure 20. The extra contact points provided by small stability pads 20 add stability to the mounting bracket 10, in its interface with vehicle IP structure 20. As a result, there is an increased dampening effect, increasing the capability of the overall natural frequency to at least 48 Hz.

In exemplary embodiments, the stability pad has at least one generally planar surface in abutting contact with the vehicle IP structure 20 and another planar surface attached to mounting bracket 10. However, the invention contemplated may not be so limited. It will be appreciated that the pads 40 may be constructed of any material, including a material similar or dissimilar to the bracket 10. In one exemplary embodiment, the pads 40 are a resilient material have an elasticity component. In another exemplary embodiment, the pads 40 have a dampening effect that reduces oscillation.

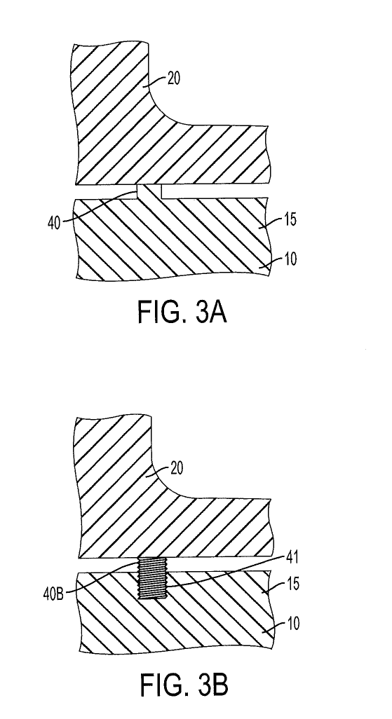

Referring to FIG. 3B, in an alternative embodiment, the pad 40b is a threaded member attached to threaded hole 41 via a threaded relationship. In certain embodiments, the threaded hole 41 is disposed in a flange surface 14 or 15. Threaded pad 40b is interposed between bracket 10 and vehicle IP structure 20. Threaded pads 40b co-act with vehicle IP structure 20 by providing an abutting or a face-to-face interaction point at each of threaded pads 40b between bracket 10 and vehicle IP structure 20. The extra contact points provided by threaded pads 40b add stability to the mounting bracket 10, in its interface with vehicle IP structure 20. As a result, there is an increased dampening effect, increasing the capability of the overall natural frequency to at least 48 Hz.

In exemplary embodiments, the threaded pad 40b has at least one generally planar surface in abutting contact with the vehicle IP structure 20. However, the invention contemplated may not be so limited. It will be appreciated that the threaded pads 40b may be constructed of any material, including a material similar or dissimilar to the bracket 10. In one exemplary embodiment, the threaded pads 40b are formed from a resilient material having an elasticity component. In another exemplary embodiment, the threaded pads 40b have a dampening effect that reduces oscillation.

Advantageously, pads 40 and 40b can reduce noise, vibration, and harshness without increasing friction within the system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A column assembly comprising:
a bracket configured to support a steering column assembly, said bracket having a first portion for receiving the column assembly and a second portion including a flange portion extending from said first portion, said flange including apertures therethrough, said flange further including a flange surface configured for attachment, and at least one stability pad attached to said surface.

2. The column assembly of claim 1, wherein said stability pad is generally planar and has a first planar surface in abutting contact with said flange surface and a second planar surface opposite said first planar surface.

3. The column assembly of claim 1, wherein said stability pad is a threaded stability pad attached to said flange surface via a threaded hole disposed within the flange portion.
